(19) United States
(12) Patent Application Publication
(10) Pub. No.: US 2026/0161383 A1
(43) Pub. Date: Jun. 11, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Takayoshi NAKAMURA, TOKYO (JP); Takashi TSUJIOKA, TOKYO (JP); Teruhiko ASAHI, TOKYO (JP)

(21) Appl. No.: 19/408,653

(22) Filed: Dec. 4, 2025

(30) Foreign Application Priority Data
Dec. 9, 2024 (JP) 2024-214277

(51) Int. Cl. G06F 8/65; B60R 21/015; G06F 3/04817

(52) U.S. Cl. CPC G06F 8/65; B60R 21/01512; G06F 3/04817

(57) ABSTRACT

A software update system including a vehicle and a server device configured to communicate with the vehicle via a network includes an update control unit configured to execute a software update process for an electronic control unit provided in the vehicle by using a new version of software supplied from the server device via the network, and an occupant detection unit configured to detect an occupant left behind in a seat of the vehicle, wherein the update control unit restricts the software update process in a case where the occupant detection unit detects the occupant left behind.

### CROSS-REFERENCE TO RELATED APPLICATIONS

This application is based upon and claims the benefit of priority from Japanese Patent Application No. 2024-214277 filed on Dec. 9, 2024, the contents of which are incorporated herein by reference.

### BACKGROUND OF THE INVENTION

### Field of the Invention

The present disclosure relates to a software update system, a software update device, a software update method, and a storage medium.

### Description of the Related Art

JP 2020-144784 A shows an in-vehicle update device that executes a program update process of an in-vehicle device.

### SUMMARY OF THE INVENTION

It is desired to favorably update the software of an electronic control unit equipped in the vehicle.

The present disclosure aims to solve the aforementioned problems.

A first aspect of the present disclosure is a software update system including a vehicle and a server device configured to communicate with the vehicle via a network, wherein the software update system includes an update control unit configured to execute a software update process for an electronic control unit provided in the vehicle by using a new version of software supplied from the server device via the network, and an occupant detection unit configured to detect an occupant left behind in a seat of the vehicle, wherein the update control unit restricts the software update process in a case where the occupant detection unit detects the occupant left behind.

A second aspect of the present disclosure is a software update system including a vehicle and a server device configured to communicate with the vehicle via a network, wherein the software update system includes a permission confirmation unit configured to perform a confirmation process to confirm with a driver of the vehicle whether to permit execution of the software update process for an electronic control unit provided in the vehicle, and an update control unit configured to execute the software update process by using a new version of software supplied from the server device via the network in a case where the driver permits the execution of the software update process, wherein in a case where the vehicle is not equipped with an occupant detection unit configured to detect an occupant left behind in the seat of the vehicle, the permission confirmation unit causes the driver to execute a permission procedure of first complexity to complete the confirmation processing, and in a case where the vehicle is equipped with the occupant detection unit, the permission confirmation unit causes the driver to execute a permission procedure of second complexity that is more complicated than the first complexity to complete the confirmation process.

A third aspect of the present disclosure is a software update device in the software update system of the first aspect, the software update device including the update control unit and the occupant detection unit.

A fourth aspect of the present disclosure is a software update device in the software update system of the second aspect, the software update device including the permission confirmation unit and the update control unit.

A fifth aspect of the present disclosure is a software update method including: an update control step of performing a software update process for an electronic control unit provided in a vehicle by using a new version of software supplied from a server device via a network; and an occupant detection step of detecting an occupant left behind in a seat of the vehicle, wherein in the update control step, the software update process is restricted in a case where the occupant left behind has been detected in the occupant detection step.

A sixth aspect of the present disclosure is a software update method including a permission confirmation step of performing a confirmation process of confirming with a driver of a vehicle whether to permit execution of a software update process for an electronic control unit provided in the vehicle, and an update control step of executing the software update process by using a new version of software supplied from a server device via a network in a case where the driver permits the execution of the software update process, wherein in a case where the vehicle is not equipped with an occupant detection unit for detecting an occupant left behind in a seat of the vehicle, in the permission confirmation step, the driver is caused to perform a permission procedure of first complexity to complete the confirmation process, and in a case where the vehicle is equipped with the occupant detection unit, in the permission confirmation step, the driver is caused to perform a permission procedure of second complexity that is more complicated than the first complexity to complete the confirmation process.

A seventh aspect of the present disclosure is a program that causes a computer to execute the software update method of the fifth aspect or the sixth aspect.

According to the present disclosure, software update can be performed favorably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic block diagram of a software update system;

FIG. 2 is a block diagram of a vehicle equipped with occupant detection capability;

FIG. 3 is a block diagram of a vehicle without occupant detection capability;

FIG. 4 is a flow chart of a sequence of processes performed in a vehicle equipped with occupant detection capability;

FIG. 5 is a schematic diagram of a permission confirmation screen;

FIG. 6 is a schematic diagram of a first disablement confirmation screen;

FIG. 7 is a schematic diagram of a second disablement confirmation screen;

FIG. 8 is a schematic diagram of a disablement notification screen;

FIG. 9 is a schematic diagram of an update status screen; and

FIG. 10 is a flow chart of a sequence of processes performed in a vehicle without occupant detection capability.

### DETAILED DESCRIPTION OF THE INVENTION

Accidents due to an occupant (occupants) being left behind in a vehicle have become a problem. Therefore, techniques have been developed to suppress the accidents caused by an occupant being left in the vehicle. For example, vehicles equipped with an occupant detection device that detects an occupant left behind in a rear seat are beginning to achieve widespread use. For example, the occupant detection device causes a display unit to display a message prompting the driver to check the rear seats, when the driver exits the vehicle. The occupant detection device sounds the horn and turns on the light when the driver is exiting even if the presence of an occupant in the rear seat is detected. Furthermore, if the occupant detection device detects the presence of an occupant in a rear seat even though the driver is exiting, the occupant detection device sends a warning to a portable terminal owned by the driver via a network such as the Internet. The occupant detection device may include in the detection the entire interior of the vehicle including the area under the seats as well as the rear seats.

Recently, vehicles equipped with OTA (Over The Air) capability have become widespread. A software update device provided in such a vehicle performs data communication with a server device of an OTA center via a network such as the Internet and performs a software update process. The software update device performs, as the software update process, each of the processes of downloading, installing, and activating a new version of software (new-version software).

While the software update device is performing the activation process, the driving of the vehicle is not allowed. That is, while the software update device executes the activation process, the driving of the vehicle is not allowed, and further, the use of each device (for example, the air conditioner) provided in the vehicle is also not allowed. Therefore, the software update device executes the activation process when the power switch of the vehicle is switched from on to off.

While the software update device is executing the activation process, the use of the above-described occupant detection device is also not allowed. That is, while the software update device is executing the activation process, even if an event occurs that an occupant is left behind in a seat of a vehicle, the driver and surrounding third parties cannot be notified.

The present disclosure, described below, contributes to preventing accidents caused by an occupant being left behind in a vehicle.

### 1 Software Update System 10

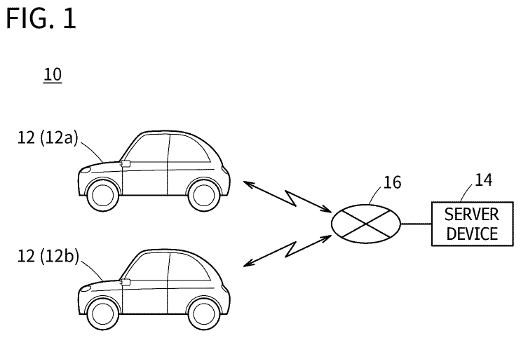

FIG. 1 is a schematic block diagram of a software update system 10. The software update system 10 includes a plurality of vehicles 12 and a server device 14. Each vehicle 12 and the server device 14 can communicate bidirectionally via a network 16 such as the Internet. The vehicles 12 include a vehicle 12a with occupant detection capability and a vehicle 12b without occupant detection capability.

### 1-1 Vehicle 12a

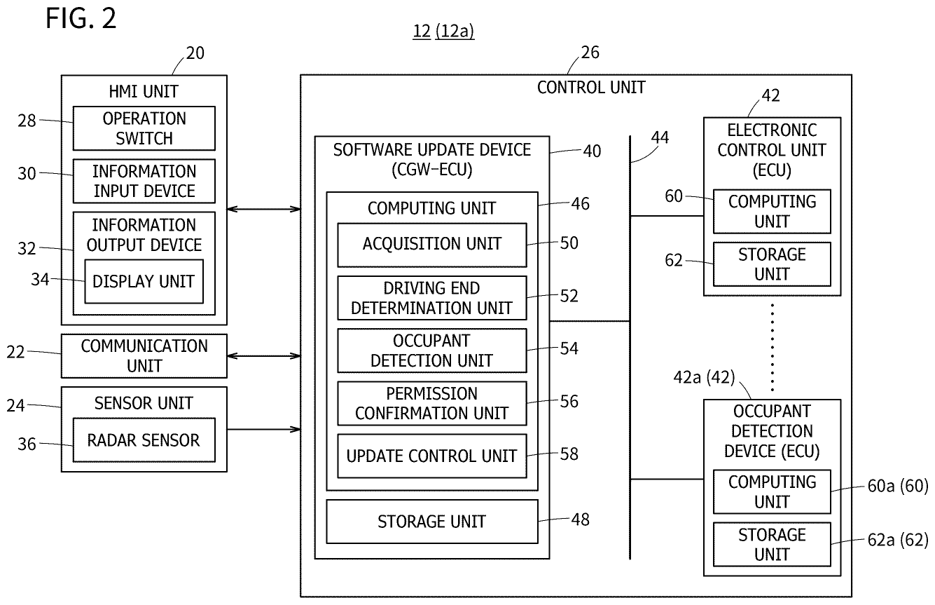

FIG. 2 is a block diagram of the vehicle 12a with occupant detection capability. The vehicle 12a includes a human-machine interface unit 20 (also referred to as HMI unit 20), a communication unit 22, a sensor unit 24, and a control unit 26.

The HMI unit 20 can be constituted by an operation switch 28, an information input device 30, and an information output device 32. The operation switch 28 is an operator (button, key switch, and so on) that can be operated by a user, such as a SSSW (Start Stop SWitch) or an IGSW (IGnition SWitch). The operation switch 28 is also a power switch that turns a power system of the vehicle 12 on and off. The information input device 30 inputs information corresponding to the user's operation to the control unit 26. The information input device 30 includes at least one of operators (keyboard, pointing device, and so on) that can be operated by the user and a voice input device such as a microphone. The information input device 30 may include a camera or the like for detecting user gestures. The information output device 32 provides the user with information output from the control unit 26. The information output device 32 includes at least one of a display unit 34 and an audio output device including a speaker. The HMI unit 20 may include a touch panel in which a pointing device and a liquid crystal display are integrated.

The communication unit 22 can be constituted by, for example, a Telematics Control Unit (TCU). The TCU can implement bidirectional communication with a device located outside the vehicle 12 (such as the server device 14). The TCU includes a communication circuit, a wireless communication module (integrated circuit module), and a microcomputer. The communication circuit performs bidirectional communication with the control unit 26. The wireless communication module performs, via the network 16, bidirectional communication with a device located outside the vehicle 12. The microcomputer performs data processing.

The sensor unit 24 can be constituted by a sensor for detecting whether or not an occupant is present in a seat. In the present specification, the term “occupant” includes animals (pets) in addition to humans. The sensor unit 24 includes, for example, a radar sensor 36. The radar sensor 36 detects the motion of an occupant in a seat. The sensor unit 24 may include sensors other than the radar sensor 36. For example, the sensor unit 24 may include a camera and an image sensor for detecting the motion of an occupant, a weight sensor for detecting the weight of the occupant, a temperature sensor for detecting the body temperature of the occupant, and the like.

The control unit 26 can be composed of a software update device 40 and a plurality of electronic control units 42. The software update device 40 executes a software update process for each electronic control unit 42. Each electronic control unit 42 executes various control functions of the vehicle 12. The software update device 40 and each electronic control unit 42 can communicate bidirectionally with each other via an in-vehicle network 44 such as a CAN bus.

The software update device 40 can be constituted by, for example, a CGW-ECU (Central GateWay-Electronic Control Unit). The software update device 40 includes a computing unit 46 and a storage unit 48.

The computing unit 46 can be constituted by a processor such as a CPU (Central Processing Unit) or a GPU (Graphics Processing Unit). That is, the computing unit 46 can be constituted by processing circuitry. The computing unit 46 includes an acquisition unit 50, a driving end determination unit 52, an occupant detection unit 54, a permission confirmation unit 56, and an update control unit 58. The acquisition unit 50, the driving end determination unit 52, the occupant detection unit 54, the permission confirmation unit 56, and the update control unit 58 can be realized by the computing unit 46 executing programs stored in the storage unit 48. At least part of the computing unit 46 may be realized by an integrated circuit such as an ASIC (Application Specific Integrated Circuit), an FPGA (Field-Programmable Gate Array), or the like. At least part of the computing unit 46 may be realized by an electronic circuit including discrete devices.

The acquisition unit 50 acquires (downloads) the new-version software distributed from the server device 14 via the network 16. The driving end determination unit 52 determines whether the driving of the vehicle 12 has ended: for example, the driving end determination unit 52 determines whether the operation switch 28 has been turned off. The occupant detection unit 54 detects that an occupant has been left behind in a seat of the vehicle 12a based on the detection result acquired from the occupant detection device 42a. The occupant detection unit 54 can perform detection of an occupant in a seat regardless of whether the vehicle 12a is being driven or not. In other words, the occupant detection unit 54 can perform seat occupant detection regardless of whether a driver is present in the driver's seat. In other words, the occupant detection unit 54 can perform occupant detection in the seats regardless of whether the operation switch 28 is turned on or off. The permission confirmation unit 56 performs a process of confirming with the user whether to permit execution of the software update process for the electronic control unit 42. The update control unit 58 executes the software update process for the electronic control unit 42 using the new-version software.

The storage unit is a computer-readable, non-transitory storage medium. The storage unit 48 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like is stored, for example, in volatile memory. Programs, tables, maps, or the like are stored, for example, in non-volatile memory. At least part of the storage unit 48 may be provided in the above-mentioned processor, integrated circuit, or the like.

The electronic control unit 42 can be constituted by, for example, an ECU (Electronic Control Unit). The electronic control unit 42 includes a computing unit 60 and a storage unit 62.

The computing unit 46 can be constituted by a processor such as a CPU, a GPU, or the like. At least part of the computing unit 46 may be realized by an integrated circuit such as an ASIC, an FPGA or the like. At least part of the computing unit 46 may be realized by an electronic circuit including discrete devices.

The storage unit 62 is a computer-readable, non-transitory storage medium, and the storage unit 62 is constituted by a volatile memory (not shown) and a non-volatile memory (not shown). The volatile memory is, for example, RAM or the like. The non-volatile memory is, for example, ROM, flash memory, or the like. Data or the like is stored, for example, in volatile memory. Programs, tables, maps, or the like are stored, for example, in non-volatile memory. At least part of the storage unit 62 may be provided in the above-mentioned processor, integrated circuit, or the like.

The non-volatile memory of the storage unit 62 includes a plurality of memory banks. The new-version software is written to one of the memory banks. For example, the new-version software is written to a memory bank other than the memory bank where the software currently in use (old version of software) has been written.

The control unit 26 is provided with an occupant detection device 42a as one of the plurality of electronic control units 42. The occupant detection device 42a includes a computing unit 60a and a storage unit 62a. The computing unit 60a executes an occupant detection process. For example, the computing unit 60a detects whether or not an occupant is present in a seat, based on the information acquired from the sensor unit 24. The computing unit 60a can detect that an occupant has been left behind in a seat of the vehicle 12a.

The computing unit 60a causes the display unit 34 to display a message prompting the driver to check the seats when the driver exits the vehicle. The computing unit 60a sounds the horn and turns on the light when the driver exits the vehicle but the presence of an occupant in a seat is detected. Furthermore, if the presence of an occupant in a seat is detected even though the driver is exiting, the computing unit 60a sends a warning to a mobile terminal owned by the driver via the network 16.

### 1-2 Vehicle 12b

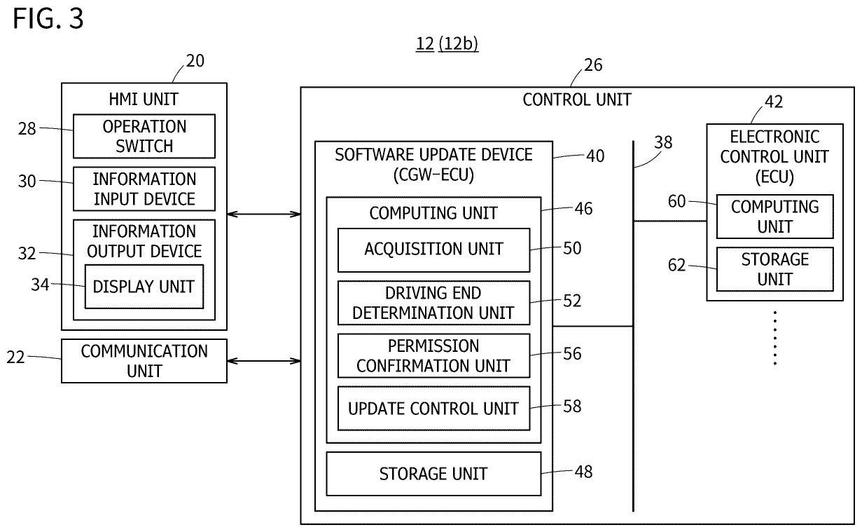

FIG. 3 is a block diagram of the vehicle 12b without occupant detection capability. In FIG. 3, the same components as in FIG. 2 are given the same reference numerals. The vehicle 12b has the same configuration as part of the vehicle 12a. On the other hand, the vehicle 12b does not include the sensor unit 24 and the occupant detection device 42a that are included in the vehicle 12a. The computing unit 46 of the vehicle 12b does not include the occupant detection unit 54 that is included in the computing unit 46 of the vehicle 12a. The vehicle 12b may be equipped with a normal occupant detection capability. The normal occupant detection capability is a capability of detecting an occupant in the vehicle only while the vehicle 12b is driven (the operation switch 28 is in the ON state).

### 1-3 Server Device 14

The server device 14 may be a physical server or a cloud server. The server device 14 may distribute information about software updates (new-version software and so on) to the vehicle 12 via the network 16.

### 2 Software Update Method

The software update system 10 performs the following three characteristic processes.

### Process 1

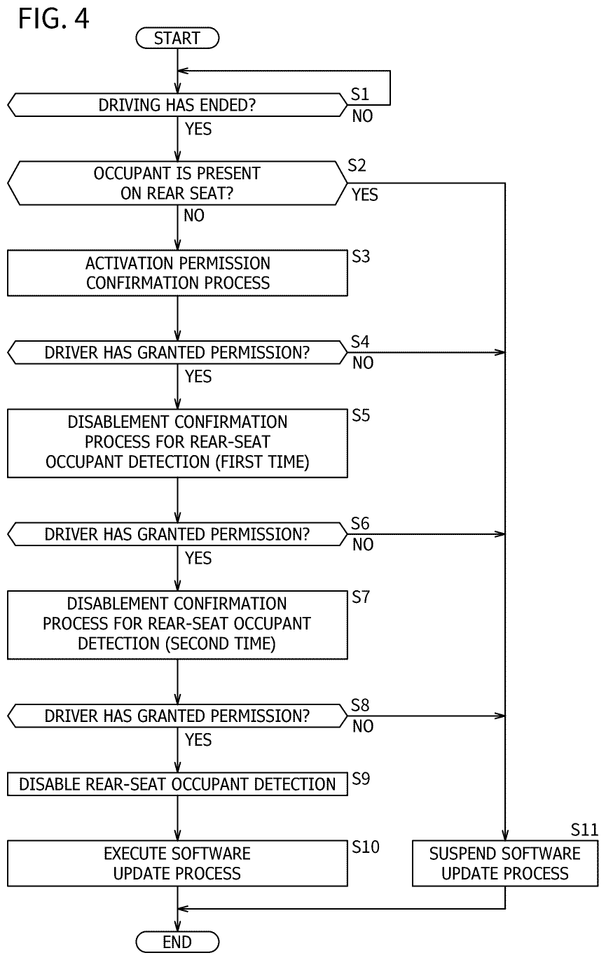

In the vehicle 12a, when the occupant detection unit 54 detects that an occupant has been left behind, the update control unit 58 restricts the software update process. As an example of the restriction on the software update process, the update control unit 58 suspends (prohibits) the activation of the downloaded new-version software (step S2: YES, step S11 in FIG. 4 described later).

### Process 2

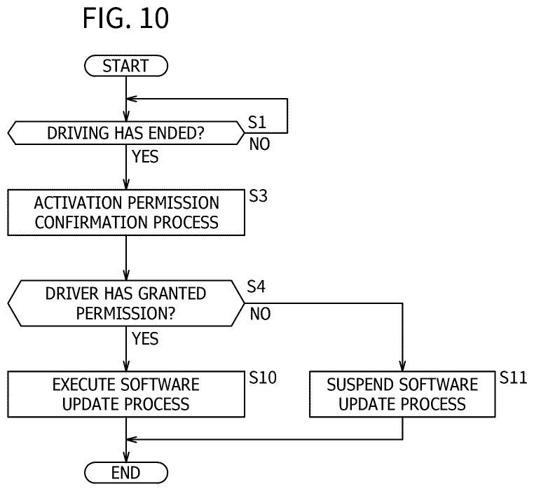

In the vehicle 12b, the permission confirmation unit 56 causes the driver to execute a permission procedure of the first complexity to complete the confirmation process. As an example of the first complexity, the permission confirmation unit 56 makes the driver execute one time an approval operation for the permission confirmation of activation (step S3 in FIG. 10 described later). With this permission confirmation, the permission confirmation unit 56 completes the confirmation process.

### Process 3

In the vehicle 12a, the permission confirmation unit 56 causes the driver to execute the permission procedure of the second complexity, which is more complicated than the first complexity, to thereby complete the confirmation process. As an example of the second complexity, the permission confirmation unit 56 makes the driver execute one time an approval operation for the permission confirmation of activation (step S3 in FIG. 4 described later). Further, the permission confirmation unit 56 makes the driver execute multiple times the approval operation for the disablement confirmation of the occupant detection (steps S5 and S7 in FIG. 4 described later). With this permission confirmation, the permission confirmation unit 56 completes the confirmation process. The second complexity may be that the operation (button operation) for a button provided at the operation switch 28 is complicated. For example, if a normal button operation is an operation (short button press operation) that requires a continuous operation time equal to or more than a first predetermined time and less than a second predetermined time, the permission procedure of the second complexity may include a button operation (long button press operation) that requires an operation time equal to or more than the second predetermined time. The driver's intention can be clearly reflected as a result of a more complex operation (long button press operation) than the normal button operation (short button press operation) being contained in the permission procedure.

### 2-1 Downloading and Installing New-Version Software

A vehicle manufacturer develops the new-version software and registers it in the server device 14. The server device 14 distributes the registered new-version software to each vehicle 12. While the vehicle 12 is driven (the operation switch 28 is in the ON state), the acquisition unit 50 executes downloading of the new-version software via the communication unit 22. Thus, the acquisition unit 50 acquires the new-version software. After the download of the new-version software ends, the update control unit 58 executes the installation of the new-version software. After the installation of the new-version software ends, the software update device 40 waits without executing the activation until the driving of the vehicle 12 ends.

### 2-2 Process in Vehicle 12a

FIG. 4 is a flow chart of a sequence of processes performed in a vehicle 12a equipped with occupant detection capability. The software update device 40 provided in the vehicle 12a executes a series of processes shown in FIG. 4 while waiting for the activation process of the new-version software.

In step S1, the driving end determination unit 52 determines whether the driving of the vehicle 12a has ended. For example, the driving end determination unit 52 determines that the driving of the vehicle 12a has ended when detecting that the operation switch 28 of the vehicle 12a is turned off. When the operation of the vehicle 12a has ended (step S1: YES), the process proceeds to step S2. On the other hand, if the operation of the vehicle 12a has not yet ended (step S1: NO), the process of step S1 is executed again.

When the process proceeds from step S1 to step S2, the occupant detection unit 54 detects whether an occupant is present in a seat of the vehicle 12a. The occupant detection unit 54 acquires from the occupant detection device 42a detection result information indicating a detection result of whether or not an occupant is present in a seat. The occupant detection unit 54 detects whether an occupant is present in a seat of the vehicle 12a, based on the acquired detection result information. If there is no occupant in any seat (step S2: NO), the process proceeds to step S3. On the other hand, if an occupant is present in a seat (step S2: YES), the process proceeds to step S11. When an occupant is present in a seat, an incident of an occupant being left behind in a seat can occur.

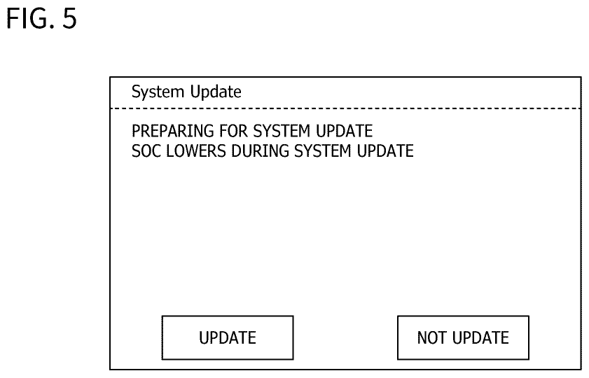

When the process proceeds from step S2 to step S3, the permission confirmation unit 56 performs a process of confirming with the driver whether to permit activation of the new-version software (activation permission confirmation process). The permission confirmation unit 56 causes the display unit 34 to display a permission confirmation screen shown in FIG. 5 within a predetermined time (for example within 2 seconds) from the time point when the driving end determination unit 52 determined that the driving by the driver ended. The permission confirmation unit 56 may cause the display unit 34 to display the permission confirmation screen and cause the audio output device to output audio for confirming whether to permit the execution of activation.

When the process proceeds from step S3 to step S4, the permission confirmation unit 56 determines whether the driver has permitted the execution of the activation of the new-version software. The driver who has viewed the permission confirmation screen shown in FIG. 5 responds to confirmation items in the permission confirmation screen via the information input device 30. The permission confirmation unit 56 acquires driver response information indicating the driver's response via the information input device 30. If the driver permits the execution of the activation of the new-version software (step S4: YES), the process proceeds to step S5. On the other hand, if the driver does not permit the execution of the activation of the new-version software (step S4: NO), the process proceeds to step S11.

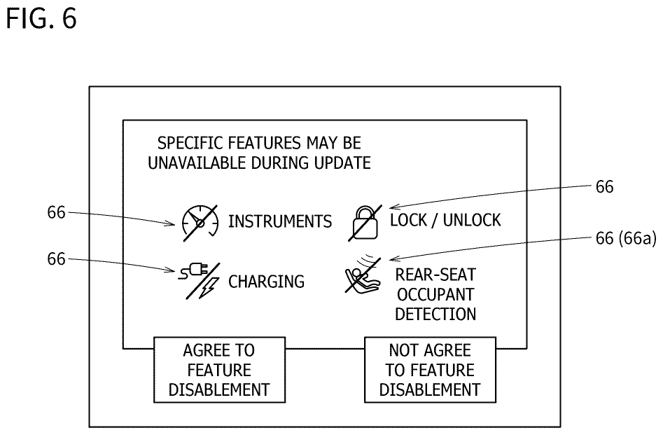

When the process proceeds from step S4 to step S5, the permission confirmation unit 56 performs a process (occupant detection disablement confirmation process) of confirming with the driver whether it is appropriate to disable the occupant detection. The permission confirmation unit 56 transitions the screen displayed on the display unit 34 from the permission confirmation screen shown in FIG. 5 to the first disablement confirmation screen shown in FIG. 6. The permission confirmation unit 56 may cause the display unit 34 to display the first disablement confirmation screen and cause the audio output device to output audio for confirming whether it is appropriate to disable the occupant detection.

The first disablement confirmation screen shown in FIG. 6 displays a plurality of icons 66 indicating features that require confirmation of disablement appropriateness. The plurality of icons 66 include an icon 66a indicating the occupant detection capability. As a result, it becomes easier for the driver to recognize that the occupant detection disablement confirmation is in progress.

When the process proceeds from step S5 to step S6, the permission confirmation unit 56 determines whether the driver has permitted the disablement of the occupant detection. The driver who has viewed the first disablement confirmation screen shown in FIG. 6 responds to the confirmation items in the first disablement confirmation screen via the information input device 30. The permission confirmation unit 56 acquires driver response information indicating the driver's response via the information input device 30. If the driver permits the disablement of the occupant detection (step S6: YES), the process proceeds to step S7. On the other hand, if the driver does not permit the disablement of the occupant detection (step S6: NO), the process proceeds to step S11.

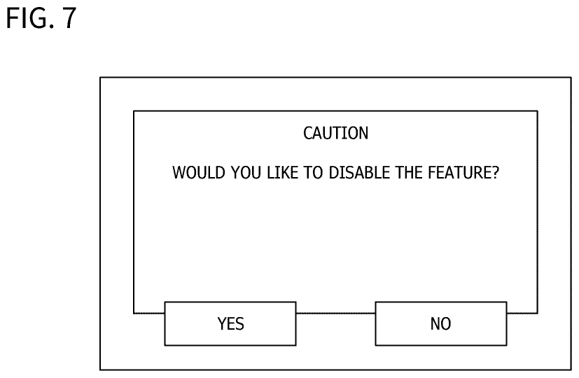

When the process proceeds from step S6 to step S7, the permission confirmation unit 56 executes the occupant detection disablement confirmation process again. The permission confirmation unit 56 transitions the screen displayed on the display unit 34 from the first disablement confirmation screen shown in FIG. 6 to the second disablement confirmation screen shown in FIG. 7. The permission confirmation unit 56 may cause the display unit 34 to display the second disablement confirmation screen and cause the audio output device to output audio for confirming whether it is appropriate to disable the occupant detection.

When the process proceeds from step S7 to step S8, the permission confirmation unit 56 determines whether the driver has permitted the disablement of the occupant detection. The driver who has viewed the second disablement confirmation screen shown in FIG. 7 responds to the confirmation items in the second disablement confirmation screen via the information input device 30. The permission confirmation unit 56 acquires driver response information indicating the driver's response via the information input device 30. If the driver permits the disablement of the occupant detection (step S8: YES), the process proceeds to step S9. On the other hand, if the driver does not permit the disablement of the occupant detection (step S8: NO), the process proceeds to step S11.

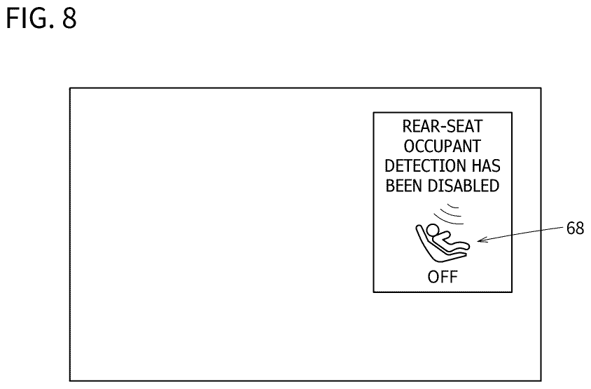

When the process proceeds from step S8 to step S9, the update control unit 58 outputs to the occupant detection device 42a a disablement instruction for disabling the occupant detection. The computing unit 60a of the occupant detection device 42a disables the occupant detection in response to the disablement instruction. The update control unit 58 confirms that the occupant detection conducted by the occupant detection device 42a has been disabled, and causes the display unit 34 to display a disablement notification screen shown in FIG. 8. An icon 68 indicating that the occupant detection has been disabled is displayed on the disablement notification screen. This allows the driver to visually recognize that the occupant detection has been disabled.

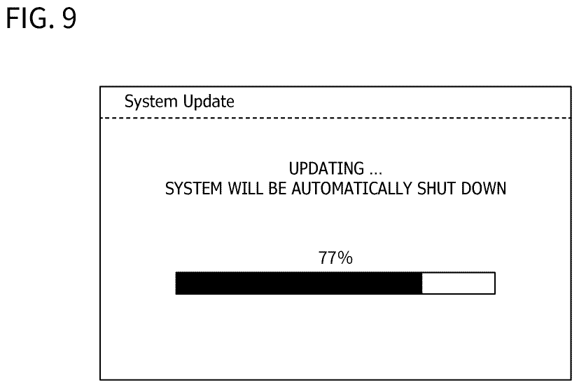

When the process proceeds from step S9 to step S10, the update control unit 58 executes activation of the new-version software. The update control unit 58 causes the display unit 34 to display an update status screen shown in FIG. 9. When the activation of the new-version software ends, the series of processes shown in FIG. 4 ends.

When the process proceeds to step S11 from any one of step S2, step S4, step S6, and step S8, the update control unit 58 suspends execution of the activation of the new-version software. This terminates the series of processes shown in FIG. 4.

When the series of processes shown in FIG. 4 ends, the power system provided in the vehicle 12a is brought into a shutdown state. When the process of step S11 is executed, the power supply to the devices for occupant detection (for example, the occupant detection device 42a and the radar sensor 36) continues even in the shutdown state.

### 2-3 Processes in Vehicle 12b

FIG. 10 is a flow chart of a sequence of processes performed in the vehicle 12b without occupant detection capability. The software update device 40 provided in the vehicle 12b executes a series of processes shown in FIG. 10 while waiting for the activation process of the new-version software.

In the software update device 40 provided in the vehicle 12b, the processes of step S1, step S3, step S4, step S10, and step S11 in the series of processes shown in FIG. 4 are executed.

### 3 Modified Example

Some functions of the control unit 26 provided in the vehicle 12 may be provided in a device (for example, the server device 14 or another device) located outside the vehicle 12.

### 4 Benefits

In the present disclosure, if the occupant detection unit 54 detects that the occupant has been left behind, the update control unit 58 suspends the software update process (step S2 in FIG. 4: YES, step S11). According to the present disclosure, it is possible to suppress an event that the occupant detection capability is disabled due to software update. That is, according to the present disclosure, it is possible to suppress an accident caused by an occupant being left behind. As a result, according to the present disclosure, software update can be performed favorably.

In the present disclosure, in the case of the vehicle 12b without occupant detection capability, the permission confirmation unit 56 causes the driver to execute a simple permission procedure (permission procedure of the first complexity) to thereby complete the software update confirmation process (step S3 in FIG. 10). On the other hand, in the case of the vehicle 12a equipped with occupant detection capability, the permission confirmation unit 56 causes the driver to execute a complicated permission procedure (permission procedure of second complexity) to complete the software update confirmation process (steps S3, S5, and S7 in FIG. 4). According to the present disclosure, in the case of the vehicle 12a with occupant detection capability, it is possible to alert the driver that the occupant detection will be disabled because of the update to the new-version software. Further, the driver's (user's) intention can be clearly reflected as a result of a more complicated operation (for example, long button press operation) than the normal button operation (for example, short button press operation) being contained in the permission procedure. This encourages the driver who exits the vehicle to be careful not to leave occupants behind in the seats. That is, according to the present disclosure, it is possible to suppress an accident caused by an occupant being left behind. As a result, according to the present disclosure, software update can be performed favorably.

A computer program (computer software) according to the present embodiment may also be referred to as a computer program product. The computer program product is not limited to computer programs recorded on the recording medium, but also includes computer programs transmitted, distributed, and downloaded via the Internet or the like.

### 5 Supplementary Notes

With respect to the above embodiments, the following Supplementary notes are further disclosed.

### Supplementary Note 1

A software update system of the present disclosure includes a vehicle (12a) and a server device (14) configured to communicate with the vehicle via a network (16), wherein the software update system (10) comprises an update control unit (58) configured to execute a software update process for an electronic control unit (42) provided in the vehicle by using a new version of software supplied from the server device via the network, and an occupant detection unit (54) configured to detect an occupant left behind in a seat of the vehicle, wherein the update control unit restricts the software update process in a case where the occupant detection unit detects the occupant left behind.

### Supplementary Note 2

In the software update system described in Supplementary note 1, the update control unit and the occupant detection unit may be provided in the vehicle.

### Supplementary Note 3

In the software update system according to Supplementary note 1, the software update process may include an activation process of activating the new version of software installed in the electronic control unit, and the update control unit may prohibit the activation process in a case where the occupant detection unit has detected the occupant.

### Supplementary Note 4

A software update system of the present disclosure includes a vehicles (12a, 12b) and a server device configured to communicate with the vehicles via a network, wherein the software update system comprises a permission confirmation unit (56) configured to confirm with a driver of the vehicle whether to permit execution of a software update process for an electronic control unit provided in the vehicle, and an update control unit configured to execute the software update process by using a new version of software supplied from the server device via the network in a case where the driver permits the execution of the software update process, and in a case where the vehicle (12b) is not provided with an occupant detection unit for detecting an occupant left behind in a seat of the vehicle, the permission confirmation unit causes the driver to execute a permission procedure of first complexity to complete the confirmation process, and in a case where the occupant detection unit is provided in the vehicle (12a), the permission confirmation unit causes the driver to execute a permission procedure of second complexity that is more complicated than the first complexity to complete the confirmation process.

### Supplementary Note 5

In the software update system described in Supplementary note 4, the permission confirmation unit may perform a disablement confirmation process of confirming with the driver whether to permit disablement of the occupant detection capability, in a case where the vehicle is equipped with the occupant detection capability.

### Supplementary Note 6

In the software update system described in Supplementary note 5, the permission confirmation unit may perform the disablement confirmation process two or more times.

### Supplementary Note 7

In the software update system according to Supplementary note 5 or 6, the software update process may include an activation process of activating the new version of software installed in the electronic control unit, and the permission confirmation unit may perform the disablement confirmation process before the activation process is performed.

### Supplementary Note 8

In the software update system according to any one of Supplementary notes 5 to 7, the permission confirmation unit may cause, in the stop confirmation process, the display unit (34) to display an icon (66a) indicating that the occupant detection is disabled.

### Supplementary Note 9

In the software update system described in Supplementary note 5, the disablement confirmation process may include a more complicated operation than a short button press operation.

### Supplementary Note 10

In the software update system described in Supplementary note 5, the disablement confirmation process may include a long button press operation.

### Supplementary Note 11

In the software update system according to Supplementary note 5, the disablement confirmation process may include an operation reflecting an intention of the user.

### Supplementary Note 12

A software update device of the present disclosure is a software update device (40) in the software update system described in any one of Supplementary notes 1 to 3 and includes the update control unit and the occupant detection unit.

### Supplementary Note 13

A software update device of the present disclosure is a software update device in the software update system according to any one of Supplementary notes 4 to 8 and includes the permission confirmation unit and the update control unit.

### Supplementary Note 14

A software update method of the present disclosure includes an update control step of executing a software update process for an electronic control unit provided in a vehicle by using a new version of software supplied from a server device via a network, and an occupant detection step of detecting an occupant left behind in a seat of the vehicle, wherein in the update control step, the software update process is restricted in a case where the occupant left behind is detected in the occupant detection step.

### Supplementary Note 15

A software update method of the present disclosure includes a permission confirmation step of performing a confirmation process of confirming with a driver of a vehicle whether to permit execution of a software update process for an electronic control unit provided in the vehicle, and an update control step of executing the software update process by using a new version of software supplied from a server device via a network in a case where the driver permits the execution of the software update process, wherein in a case where the vehicle is not equipped with an occupant detection unit for detecting an occupant left behind in a seat of the vehicle, in the permission confirmation step, the driver is caused to perform a permission procedure of first complexity to complete the confirmation process, and in a case where the vehicle is equipped with the occupant detection unit, in the permission confirmation step, the driver is caused to perform a permission procedure of second complexity that is more complicated than the first complexity to complete the confirmation process.

### Supplementary Note 16

A program of the present disclosure causes a computer to perform the software update method described in Supplementary note 14 or 15.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example and are not limited to these. The same applies to the case where numerical values or mathematical expressions are used in the description of the above-described embodiment.

1. A software update system comprising a vehicle and a server device configured to communicate with the vehicle via a network, the software update system comprising
one or more processors that execute computer-executable instructions stored in a memory,
wherein
the one or more processors execute the computer-executable instructions to cause the software update system to:
execute a software update process for an electronic control unit provided in the vehicle by using a new version of software supplied from the server device via the network;
detect an occupant left behind in a seat of the vehicle; and
restrict the software update process in a case where the occupant left behind has been detected.

2. The software update system according to claim 1, wherein
at least part of the one or more processors is provided in the vehicle, and
the one or more processors execute the computer-executable instructions to cause the software update system to:
execute the software update process; and
detect the occupant left behind in the seat of the vehicle.

3. The software update system according to claim 1, wherein
the software update process includes an activation process of activating the new version of software installed in the electronic control unit, and
the one or more processors execute the computer-executable instructions to cause the software update system to
prohibit the activation process in a case where the occupant has been detected.

4. A software update system comprising a vehicle and a server device configured to communicate with the vehicle via a network, the software update system comprising
one or more processors that execute computer-executable instructions stored in a memory,
wherein the one or more processors execute the computer-executable instructions to cause the software update system to:
execute a confirmation process to confirm with a driver of the vehicle whether to permit execution of a software update process for an electronic control unit provided in the vehicle;
execute the software update process by using a new version of software supplied from the server device via the network in a case where the driver permits the execution of the software update process;
cause the driver to execute a permission procedure of first complexity to complete the confirmation process, in a case where the vehicle is not equipped with occupant detection capability for detecting an occupant left behind in a seat of the vehicle; and
cause the driver to execute a permission procedure of second complexity that is more complicated than the first complexity to complete the confirmation process, in a case where the vehicle is equipped with occupant detection capability.

5. The software update system according to claim 4, wherein
the one or more processors execute the computer-executable instructions to cause the software update system to
execute a disablement confirmation process of confirming with the driver whether to permit disablement of the occupant detection capability, in a case where the vehicle is equipped with the occupant detection capability.

6. The software update system according to claim 5, wherein
the one or more processors execute the computer-executable instructions to cause the software update system to
execute the disablement confirmation process two or more times.

7. The software update system according to claim 5, wherein
the software update process includes an activation process of activating the new version of software installed in the electronic control unit, and
the one or more processors execute the computer-executable instructions to cause the software update system to
execute the disablement confirmation process before the activation process is executed.

8. The software update system according to claim 5, wherein
the one or more processors execute the computer-executable instructions to cause the software update system to
cause, in the disablement confirmation process, a display unit to display an icon indicating that occupant detection is disabled.

9. The software update system according to claim 5, wherein the disablement confirmation process includes a more complicated operation than a short button press operation.

10. The software update system according to claim 5, wherein the disablement confirmation process includes a long button press operation.

11. The software update system according to claim 5, wherein the disablement confirmation process includes an operation reflecting an intention of a user.

12. A software update device in the software update system according to claim 1, wherein the computer-executable instructions comprise the one or more processors.

13. A software update device in the software update system according to claim 4, wherein the computer-executable instructions comprise the one or more processors.

14. A software update method executed by one or more processors, the method comprising:
executing a software update process for an electronic control unit provided in a vehicle by using a new version of software supplied from a server device via a network; and
detecting an occupant left behind in a seat of the vehicle,
wherein
in the executing of the software update process, the software update process is restricted in a case where the occupant left behind in the seat of the vehicle has been detected in the detecting of the occupant.

15. A software update method executed by one or more processors, the method comprising:
executing a confirmation process of confirming with a driver of a vehicle whether to permit execution of a software update process for an electronic control unit provided in the vehicle; and
executing the software update process by using a new version of software supplied from a server device via a network, in a case where the driver permits the execution of the software update process,
wherein
in a case where the vehicle is not equipped with occupant detection capability for detecting an occupant left behind in a seat of the vehicle, in the executing of the confirmation process, the driver is caused to execute a permission procedure of first complexity to complete the confirmation process, and
in a case where the vehicle is equipped with the occupant detection capability, in the executing of the confirmation process, the driver is caused to execute a permission procedure of second complexity that is more complicated than the first complexity to complete the confirmation process.

16. A non-transitory storage medium storing a program for causing a computer to execute the software update method according to claim 14.

17. A non-transitory storage medium storing a program for causing a computer to execute the software update method according to claim 15.
